(19) United States
(12) Patent Application Publication
(10) Pub. No.: US 2017/0323749 A1
(43) Pub. Date: Nov. 9, 2017

(54) Magnetic Flux Assembly For A Relay, And Relay

(71) Applicant: Tyco Electronics Austria GmbH, Vienna (AT)

(72) Inventors: Markus Gutmann, Brand (AT); Rudolf Mikl, Maria Ellend (AT); Paul Indrajit, Markdorf (DE)

(73) Assignee: Tyco Electronics Austria GmbH, Vienna (AT)

(21) Appl. No.: 15/661,136

(22) Filed: Jul. 27, 2017

Related U.S. Application Data
(63) Continuation of application No. PCT/EP2016/052003, filed on Jan. 29, 2016.

(30) Foreign Application Priority Data
Jan. 30, 2015 (EP) 15153203.3

(51) Int. Cl. H01H 50/24; H01H 50/40

(52) U.S. Cl. CPC H01H 50/24; H01H 50/40

(57) ABSTRACT

A magnetic flux assembly for closing a magnetic circuit of a relay and a relay. The magnetic flux assembly has a yoke and a U-shaped armature that is movable relative to the yoke. The yoke has a coil part that is in a coil and a flux conduction part that conducts the magnetic flux generated by the coil.

### CROSS-REFERENCE TO RELATED APPLICATIONS

This application is a continuation of PCT International Application No. PCT/EP2016/052003 filed on Jan. 29, 2016, which claims priority under 35 U.S.C. §119 to EP 15153203.3, filed Jan. 30, 2015.

### FIELD OF THE INVENTION

The invention relates to a magnetic flux assembly for closing a magnetic circuit of a relay and a relay.

### BACKGROUND

Relays usually comprise a coil that is attached to a control circuit. When the coil is energized, it creates a magnetic flux which is then guided by a yoke. The magnetic flux then creates a magnetic force that attracts an armature and tries to pull the armature towards the yoke and to close the magnetic circuit. A problem associated with known relays is that high magnetic forces, and thus a high current in the control circuit or a high number of windings in the coil, are necessary for switching, in particular, if a load circuit connected to the armature is closed in the open position of the magnetic flux assembly.

### SUMMARY

According to a first aspect of the present invention, a magnetic flux assembly for closing a magnetic circuit of a relay includes a yoke and a U-shaped armature movable relative to the yoke. The yoke has a coil part in a coil and a flux conduction part that conducts magnetic flux generated by the coil.

According to a second aspect of the present invention, a relay includes a coil and a magnetic flux assembly that has a yoke and a U-shaped armature movable relative to the yoke. The yoke has a coil part in the coil and a flux conduction part that conducts magnetic flux generated by the coil.

### BRIEF DESCRIPTION OF THE DRAWINGS

In the drawings:

FIG. 1 is a side view of a magnetic flux assembly constructed in accordance with the present invention.

FIG. 2 is a perspective view of the FIG. 1 magnetic flux assembly together with other parts of a relay.

### DETAILED DESCRIPTION OF THE EMBODIMENT(S)

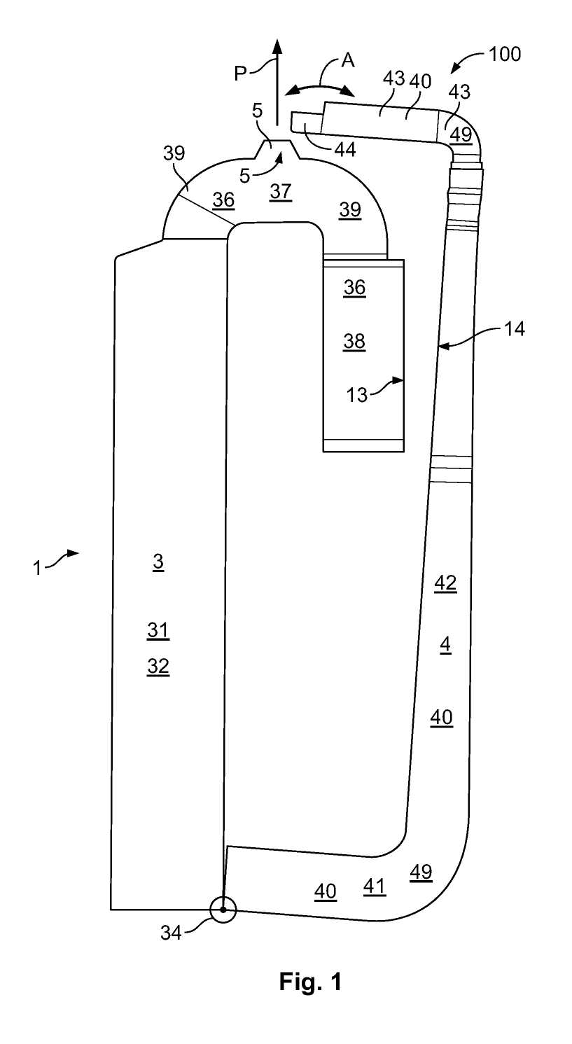

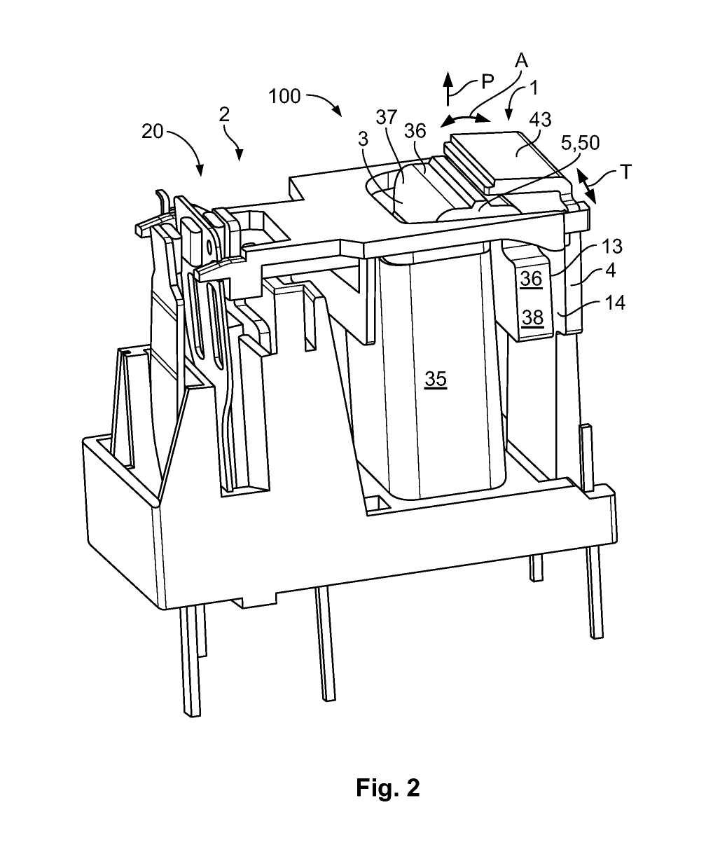

In FIGS. 1 and 2, a magnetic flux assembly 1 for closing a magnetic circuit of an electromagnetic switching device 2 in the form of a relay 20 is depicted. A side view is shown in FIG. 1. A perspective view of the magnetic flux assembly 1 together with other parts of the relay 20 is shown in FIG. 2.

The magnetic flux assembly 1 comprises a yoke 3 and an armature 4 that is movable relative to the yoke 3. The armature 4 can move relative to the yoke 3 by tilting or pivoting the armature in an actuation direction A about a hinge axis 34 where the armature 4 is coupled to the yoke 3.

The yoke 3 comprises a coil part 31 in the form of a leg 32 that is received in a coil 35. The yoke 3 further comprises a flux conduction part 36 in the form of a central leg 37 and a further leg 38. When the coil 35 is energized, that means when a current is running through the control circuit, magnetic flux is generated in the coil 35. The coil part 31 receives this magnetic flux and conducts it to the flux conduction part 36. The yoke 3 creates a magnetic force that tries to pull the armature 4 towards the yoke and close the magnetic circuit.

The yoke 3 and the armature 4 each have a magnetic attraction faces 13 and 14, respectively, which provide a large area so that a high magnetic force can be achieved. The magnetic attraction faces 13, 14 face towards the other element and lie opposite to each other in the open state 100 depicted in FIGS. 1 and 2. In a closed state, the two magnetic attraction faces 13, 14 rest on each other and act as a limit stop for the movement of the armature 4 relative to the yoke 3. The magnetic attraction faces 13, 14 can correspond to each other in size and geometry to achieve a good effect.

The magnetic attraction face 13 on the yoke 3 can be located at a free end so that maximum concentration of the magnetic flux in the magnetic attraction face is possible. As a result, the effect is enhanced and the current necessary for switching can be reduced.

The magnetic attraction face 14 of the armature 4 can be located at the base or the central leg 42. A force distribution can be better than when the magnetic attraction base is located at an end.

The magnetic attraction faces 13, 14 serve to provide big surface areas so that an attractive magnetic force is higher. The magnetic attraction faces 13, 14 can be perpendicular to a direction A of relative movement between the yoke 3 and the armature 4 to achieve the best possible results. The magnetic attraction faces 13, 14 serve as a stop for the armature in the closed state. As a result, the magnetic attraction faces 13, 14 each have a double function which minimizes the number of parts and the space requirements.

The armature 4 is U-shaped. It has three legs 41, 42, and 43 that are connected to each other via the bends 49. A proximal leg 41 is hinged to the coil part 31 of the yoke 3 and is perpendicular to the coil part 31.

A central leg 42 is between the proximal leg 41 and a distal leg 43. The central leg 42 is at 90° angles to the proximal leg 41 and the distal leg 43. The central leg 42 comprises, in particular, the magnetic attraction face 14 that is wider than faces immediately adjacent to it.

In another advantageous embodiment, in the open position the distance between a distal leg 43 of the armature 4 and the yoke 3 is smaller than a distance between a central leg 42 of the armature 4 and the yoke 3. The distal leg 43 can be a leg that is further away from a hinge point 34 than the other legs. By this configuration, a maximum lever length can be achieved.

In the open position 100, the two magnetic attraction faces 13 and 14 are spaced apart considerably from each other. Thus, a high magnetic flux and a high current in the coil 35 would be necessary to switch the magnetic flux assembly 1 to the closed position, if only this mechanism would be present. However, in order to make the switching easier, the armature 4 is U-shaped and has, in particular, the distal leg 43. This distal leg 43 overlaps the yoke 3 at least in sections. In particular, it overlaps the central leg 37 of the yoke 3 in the open position. In this open position 100, the distance between the distal leg 43 and the central leg 37 of the yoke 3 is smaller than the distance between the two magnetic attraction faces 13, 14. Thus, a lower current is necessary to initiate the movement of the armature 4 from the open position 100. This is particularly important when, in the open position 100 of the magnetic flux assembly, a load circuit is closed and/or biased, for example by a spring.

A magnetic attraction face of the yoke 3 can be opposite a magnetic attraction face of the armature 4 in an open position to achieve the maximum effect. In particular, the two magnetic attraction faces can rest against each other in a closed state. The faces can correspond to each other in size and in geometry to achieve a good effect.

The magnetic attraction face 13 of the yoke 3 can be located at a free end so that a maximum concentration of the magnetic flux in the face is possible. As a result, the effect is enhanced and the current necessary for switching can be reduced.

The magnetic attraction face 14 of the armature 4 can be located at the base or a central leg 42. A force distribution can be better than when the magnetic attraction face is located at an end.

In this embodiment, the yoke 3 is basically U-shaped with three legs 32, 37, and 38. In a simpler configuration, the yoke 3 could be L-shaped. In particular, the second outer leg 38 could be removed. In this case, the armature 4 could, for example, be limited in its movement by the central leg 37 of the yoke 3.

In yoke 3, one leg can be shorter than the other leg. In particular, the leg 38, outside the coil 35, can be shorter than the leg 32 arranged inside the coil in order to save space. In an alternative embodiment, two outer legs 32 and 38 can be connected by a central leg 37 or part that is at least section-wise straight, to allow a design in which one of the outer legs can be spaced further away from the other outer leg. The two outer legs 32 and 38 can, in particular, be parallel to each other.

In order to improve the effect of the overlapping distal leg 43, a protrusion 5 is located on the central leg 37. The protrusion 5 protrudes in a protrusion direction P that is basically perpendicular to the actuation direction A. The protrusion 5 protrudes towards the distal leg 43, directing the magnetic flux onto the distal leg 43. The protrusion 5 does not limit the movement of the armature 4 in the actuation direction. Rather, the armature 4 can pass the protrusion during this movement.

In order to concentrate the magnetic flux in the distal leg 43, the distal leg has a tip 44, the width of which in the protrusion direction P is smaller than the rest of the distal leg 43.

The protrusion 5, shown in FIGS. 1 and 2, has a trapezoidal cross-section. This trapezoidal cross-section is easy to produce by embossing or stamping. In order to concentrate the magnetic flux further, the protrusion 5 could have a different cross-section, for example a triangular or a rectangular cross-section with smaller angles can lead to a better effect as the magnetic flux can be more concentrated in such sharp corners. For example, a rectangular cross-section could be possible. Further, the protrusion 5 could at least in sections have a round cross-section, for example a semi-circular cross-section.

The protrusion 5 can, in particular, be arranged on an outer face of the armature 4 so that a high flux density can be achieved. In the case of a U-shaped yoke 3, the protrusion 5 can be located on a central part in order to enable a compact design.

The fact that the distal leg 43 of the armature 4 is the part that overlaps the yoke 3 in the open position 100, guarantees that the length of the lever relative to the hinge axis 34 is long. Thus, even a small force between the protrusion 5 and the distal leg 43 can ensure that the magnetic flux assembly is being closed.

The protrusion 5 is an elongated rib 50. The elongated rib 50 extends along a transverse direction T that is perpendicular to the actuation direction A and the protrusion direction P. The elongated configuration of the protrusion 5 results in a long interaction area for interaction between the protrusion 5 and the distal leg 43. By this, the effect can be enhanced and the magnetic flux necessary for switching can be lower. Further, an elongated rib can be produced easily.

The relay 20 can have an open position and a closed position. In the open position, the armature 4 is closer to the yoke 3 than in the closed position. In the open position, the armature 4 overlaps the yoke 3 at least in sections. This helps to generate the initial force for closing the magnetic flux assembly. In particular, the yoke 3 and/or the armature 4 can comprise overlapping elements that are designed to overlap the other one of the two. These overlapping elements can give a defined overlap.

What is claimed is:

1. A magnetic flux assembly for closing a magnetic circuit of a relay comprising:
a yoke having:
(a) a coil part in a coil, and
(b) a flux conduction part that conducts magnetic flux generated by the coil; and
a U-shaped armature movable relative to the yoke.

2. A magnetic flux assembly according to claim 1, wherein the armature is hinged to the yoke.

3. A magnetic flux assembly according to claim 2, wherein the yoke is L-shaped.

4. A magnetic flux assembly according to claim 2, wherein the yoke is U-shaped.

5. A magnetic flux assembly according to claim 1, wherein the yoke has a protrusion that conducts magnetic flux towards the armature.

6. A magnetic flux assembly according to claim 5, wherein the protrusion is an elongated rib extending transverse to movement of the armature relative to the yoke.

7. A magnetic flux assembly according to claim 6, wherein the protrusion has a trapezoidal cross-section.

8. A magnetic flux assembly according to claim to 7, wherein the protrusion is embossed.

9. A magnetic flux assembly according to claim to 8, wherein:
(a) the armature has a magnetic attraction face, and
(b) the yoke has a magnetic attraction face facing the magnetic attraction face of the armature that is wider than faces immediately adjacent to the magnetic attraction of the yoke.

10. A relay comprising:
a coil; and
a magnetic flux assembly comprising:
(a) a yoke having:
(1) a coil part in the coil, and
(2) a flux conduction part that conducts magnetic flux generated by the coil, and
(b) a U-shaped armature movable relative to the yoke.

11. A relay according to claim 10, further including an electromagnetic switching device that has an open position and a closed position, and wherein:
(a) in the closed position, the armature is closer to the yoke than in the open position, and
(b) in the open position, the armature at least partially overlaps the yoke.

12. A relay according to claim 11, wherein:
(a) the armature has:
(1) a proximal leg
(2) a central leg
(3) a distal leg
(b) in the open position a distance between a distal leg of the armature and the yoke is smaller than a distance between a central leg of the armature and the yoke.

13. A magnetic flux assembly according to claim 12, wherein the armature is hinged to the yoke.

14. A magnetic flux assembly according to claim 13, wherein the yoke is L-shaped.

15. A magnetic flux assembly according to claim 13, wherein the yoke is U-shaped.

16. A magnetic flux assembly according to claim 17, wherein the yoke has a protrusion through which magnetic flux is conducted towards the armature.

17. A magnetic flux assembly according to claim 16, wherein the protrusion has a trapezoidal cross-section.

18. A magnetic flux assembly according to claim 19, wherein the protrusion is embossed.

19. A magnetic flux assembly according to claim 18, wherein the yoke has a magnetic attraction face facing the armature that is wider than faces immediately adjacent to it.
